(19) United States
(12) Patent Application Publication
(10) Pub. No.: US 2012/0057270 A1
(43) Pub. Date: Mar. 8, 2012

(54) CAPACITOR AND METHOD FOR MAKING SAME

(76) Inventor: Juergen FOERSTER, Tegernheim (DE)

(21) Appl. No.: 12/876,183

(22) Filed: Sep. 6, 2010

(51) Int. Cl. H01G 4/06; H01G 9/00

(52) U.S. Cl. 361/311; 29/25.03

(57) ABSTRACT

One or more embodiments relate to a capacitor, comprising: a first electrode comprising a first layer including tantalum nitride, and a second layer including alpha-tantalum overlying the first layer; a dielectric layer; and a second electrode overlying the dielectric layer, the second electrode comprising a first layer including tantalum nitride, and a second layer including alpha-tantalum overlying the first layer.

### FIELD OF THE INVENTION

Generally, the present invention relates to semiconductor structures, and, in particular, to semiconductor structures including capacitors.

### BACKGROUND OF THE INVENTION

Capacitors may be a part of semiconductor structures. For example, capacitors may be part of semiconductor chips, integrated circuits or semiconductor devices. Examples of capacitors include, but not limited to, stacked capacitors, metal-insulator-metal (MIM) capacitors, trench capacitors and vertical-parallel-plate (VPP) capacitors. New capacitor structures are needed.

### BRIEF DESCRIPTION OF THE DRAWINGS

FIG. 1A shows a capacitor arrangement in accordance with an embodiment of the present invention;

FIG. 1B shows a capacitor arrangement in accordance with an embodiment of the present invention;

FIG. 1C shows a capacitor arrangement in accordance with an embodiment of the present invention;

FIG. 1D shows a capacitor arrangement in accordance with an embodiment of the present invention;

FIG. 2 shows a capacitor arrangement in accordance with an embodiment of the present invention;

FIGS. 3A through 3F shows a method of making a capacitor arrangement in accordance with an embodiment of the present invention; and

FIG. 4A through 4D shows a method of making a capacitor arrangement in accordance with an embodiment of the present invention.

### DETAILED DESCRIPTION OF THE INVENTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

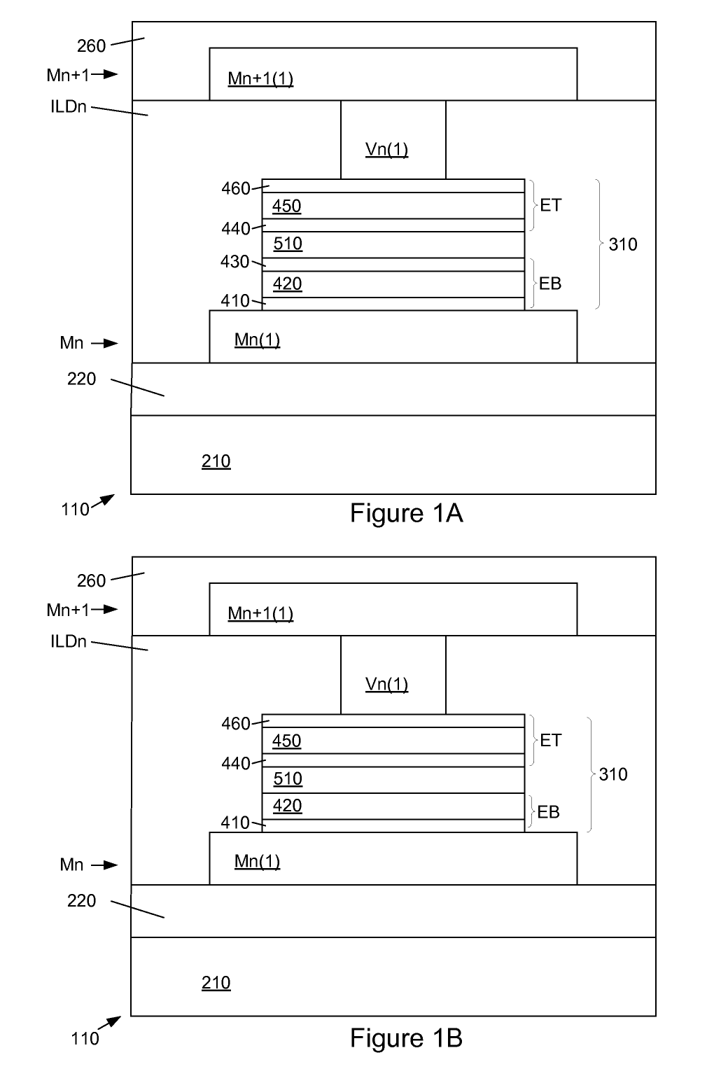

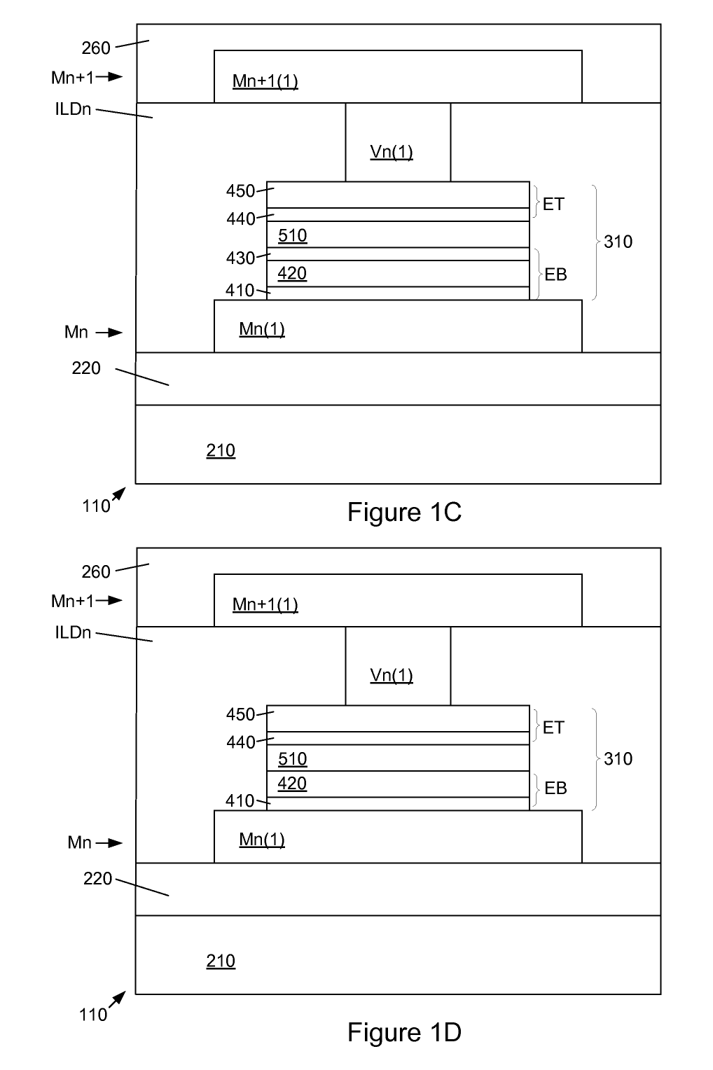

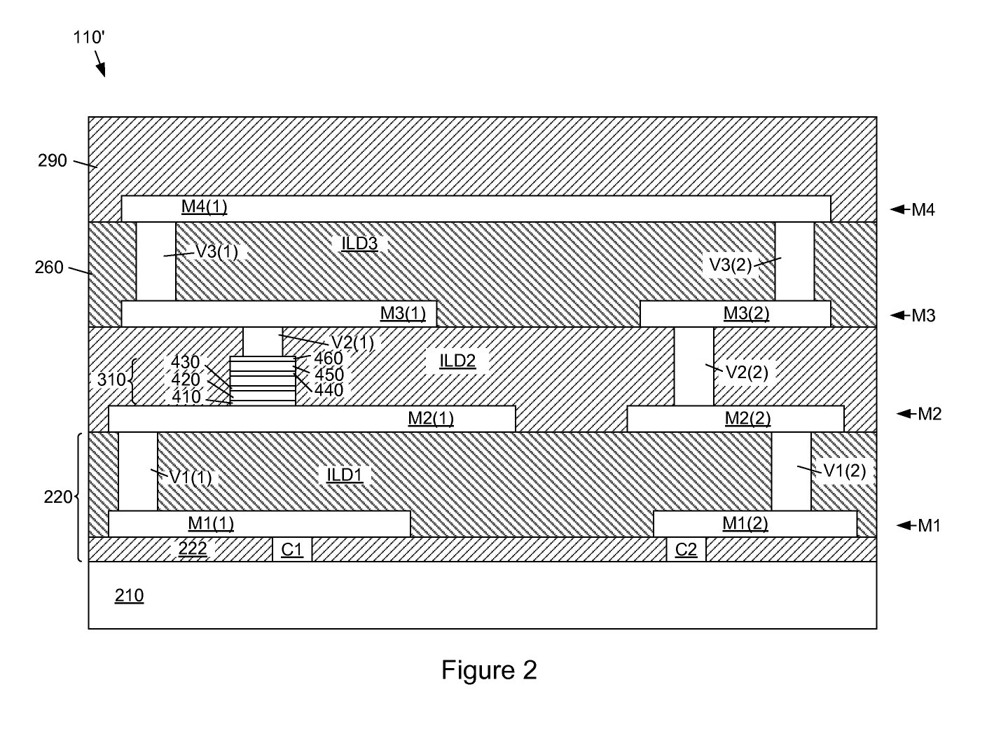

FIG. 1A shows a semiconductor structure 110 which is an embodiment of the present invention. The semiconductor structure may, for example, represent a semiconductor chip, an integrated circuit and/or a semiconductor device. The semiconductor structure 110 includes a substrate 210. A layer 220 may be disposed over the substrate. The layer 220 may include, without limitation, one or more dielectric layers (such as interlevel dielectric layers), one or more metallization levels, one or more conductive vias as well as one or more conductive contacts. An example of layer 220 is provided in FIG. 2 and is explained in more detail below. The substrate 210 may include active areas, components or other material layers formed therein. The semiconductor structure 110 includes a capacitor 310. In one or more embodiments, the capacitor 310 may be an integrated capacitor which is integrated as part of a semiconductor chip and/or integrated circuit. A semiconductor chip may include an integrated circuit and the integrated capacitor may be integrated as part of the integrated circuit. In one or more embodiments, the capacitor 310 may be a metal-insulator-metal (MIM) capacitor.

The substrate 210 may be any type of substrate. For example, the substrate may be a semiconductor substrate. In one or more embodiments, the semiconductor substrate may be a bulk semiconductor substrate such as a bulk silicon substrate. In one or more embodiments, the semiconductor substrate may be an SOI substrate. The SOI substrate may, for example, include a bulk semiconductor substrate, an insulator layer disposed over the bulk semiconductor substrate and a semiconductor layer disposed over the insulator layer. The bulk semiconductor substrate may be a bulk silicon substrate, the insulator layer may be a silicon oxide layer (such as a buried oxide layer) and the semiconductor layer may be a silicon layer. The SOI substrate may be formed by a SIMOX process. In one or more embodiments, the semiconductor substrate may be a silicon-on-sapphire (SOS) substrate. In one or more embodiments, the semiconductor substrate may be a germanium-on-insulator (GeOI) substrate. The semiconductor substrate may include one or more materials such as semiconductor materials such as silicon germanium, germanium, germanium arsenide, indium arsenide, indium arsenide, indium gallium arsenide, or indium antimonide.

The semiconductor structure 110 may include a plurality of metallization levels. A metallization level may be any metallization level including Metal-1, Metal-2, Metal-3, all the way up to an including the final metal level. The semiconductor structure 110 may include at least the metallization level Mn and the metallization level Mn+1 which is above the metallization level Mn. The metallization levels Mn and Mn+1 are adjacent metallization levels such that there is no other metallization level between the two. As an example, Mn may be Metal-1 while Mn+1 may be Metal-2. As another example, Mn may be Metal-2 while Mn+1 may be Metal-3.

In one or more embodiments, the metallization level Mn may be the lowest metallization level such as Metal-1. In another embodiments, the metallization level Mn may be, for example, Metal-2, Metal-3 or even higher. In one or more embodiments, there may be one or more additional metallization levels below Mn. As noted these metallization levels may be included within the layer 220.

In one or more embodiments, the metallization level Mn+1 may be the final, highest or top-most metallization level. However, in another embodiment, the semiconductor structure 110 may also include metallization levels above Mn+1.

Each of the metallization levels Mn and Mn+1 may include one or more metal lines. A metal line may include a pad structure (e.g. a landing pad, a bond pad, a contact pad, etc.). In one or more embodiments, a metal line may be useful for routing signals primarily in a horizontal direction. The metal lines of a metallization level may be spaced apart from each other. Two or more of the metal lines of a metallization level may be electrically isolated from each other.

As shown in FIG. 1A, the metallization level Mn includes metal line Mn(1). Likewise, the metallization level Mn+1 includes the metal line Mn+1(1). The metal lines may, for example, comprise any a metallic material such as a metal or a metallic alloy. It is conceivable, in some embodiments, that the metal lines be replaced with conductive lines that include any conductive material (e.g. metallic or non-metallic).

In one or more embodiments, a metallic alloy may include at least two different metallic elements. In one or more embodiments, a metallic alloy may include at least one metallic element and at least one non-metallic element.

A capacitor 310 may be formed over the metal line Mn(1). The capacitor 310 includes a first electrode (e.g. bottom electrode) EB, a second electrode (e.g. top electrode) ET and a dielectric layer 510 disposed between the first electrode EB and the second electrode ET.

In one or more embodiments, the first electrode EB may include a stack of three conductive layers 410, 420, 430. The first electrode EB includes a first conductive layer 410 disposed over the metal line Mn(1), a second conductive layer 420 disposed over the first conductive layer 410, and a third conductive layer 430 disposed over the second conductive layer 420. In one or more embodiments, the first electrode EB may include a stack of more than three conductive layers.

A dielectric layer 510 may be formed over the first electrode EB and may serve as the dielectric layer for the capacitor 310. The dielectric layer 510 may be formed by a deposition process or a growth process. In one or more embodiments, the dielectric layer 510 may be formed by an atomic layer deposition process.

The dielectric layer 510 may comprise one or more dielectric materials. A dielectric material may include at least one of oxides (such as silicon oxide and aluminum oxide), nitrides (such as silicon nitride), and oxynitrides (such as silicon oxynitride). In one or more embodiments, a dielectric material may be a homogeneous material. In one or more embodiments, a dielectric material may be a heterogeneous material. In one or more embodiments, a dielectric material may be a mixture or combination of materials. In one or more embodiments, the dielectric layer 510 may be a homogeneous layer. In one or more embodiments, the dielectric layer 510 may include a mixture or combination of two or more materials. In one or more embodiments, the dielectric layer 510 may itself include a stack of two or more sub-layers of different materials. In one or more embodiments, the dielectric layer 510 may comprise or consist essentially of aluminum oxide (for example, Al₂O₃).

In one or more embodiments, the dielectric layer 510 may comprise (or may consist essentially of) a high-k dielectric material. In one or more embodiments, the high-k material may have a dielectric constant greater than about 3.9. In some embodiments, the high-k material may have a dielectric constant greater than that of silicon dioxide. In some embodiments, the high-k material may have a dielectric constant greater than about 7. In some embodiments, the high-k material may have a dielectric constant greater than that of silicon nitride. In one or more embodiments, the high-k material may be an oxide. In one or more embodiments, the high-k material may comprise aluminum oxide. In one or more embodiments, the high-k material may comprise one or more materials selected from the group consisting of Al₂O₃, ZrO₂, HfO₂, TiO₂, SrTiO₃, and BaSrTiO₃. Hence, in one or more embodiments, the dielectric layer 510 may comprise one or more materials selected from the group consisting of Al₂O₃, ZrO₂, HfO₂, TiO₂, SrTiO₃, and BaSrTiO₃.

In one or more embodiments, the dielectric layer 510 may be deposited by an atomic layer deposition (e.g. ALD).

A second electrode (e.g. top electrode) ET may be disposed over the dielectric layer 510. In one or more embodiments, the second electrode ET may include a stack of three conductive layers 440, 450 and 460. The second electrode ET includes a fourth conductive layer 440 disposed over the dielectric layer 510, a fifth conductive layer 450 disposed over the fourth conductive layer 440, and a sixth conductive layer 460 disposed over the fifth conductive layer 450. In one or more embodiments, the second electrode ET may include more than three conductive layers.

Referring to FIG. 1B, in one or more embodiments, it is possible that the third conductive layer 430 (shown in FIG. 1A) be excluded. In this case, the first electrode EB may include the first conductive layer 410 and the second conductive layer 420 but not the third conductive layer 430. FIG. 1B shows a semiconductor structure 110 that includes a capacitor 310.

Referring to FIG. 1C, in one or more embodiments, it is possible that the sixth conductive layer 460 (that is shown in FIG. 1A) be excluded. In this case, the second electrode ET may include the fourth conductive layer 440 and the fifth conductive layer 450 but not the sixth conductive layer 460. FIG. 1C shows a semiconductor structure 110 that includes a capacitor 310.

Referring to FIG. 1D, in one or more embodiments, it is possible that the third conductive layer 430 (that is shown in FIG. 1A) be excluded and that the sixth conductive layer 460 (that is shown in FIG. 1A) also be excluded. In this case the first electrode EB may include first conductive layer 410 and the second conductive layer 420 but not the third conductive layer 430. Likewise, in this case, the second electrode ET may include the fourth conductive layer 440 and the fifth conductive layer 450 but not the sixth conductive layer 460. FIG. 1D shows a semiconductor structure 110 that includes a capacitor 310.

In one or more embodiment, one or more of the conductive layers 410, 420, 430, 440, 450, 460 may be metallic layers. In one or more embodiment, each of the conductive layers 410, 420, 430, 440, 450, 460 may be metallic layers.

In one or more embodiments, one or more of the conductive layers 410, 420, 430, 440, 450, 460 may be homogeneous layers. In one or more embodiments, each of the conductive layers 410, 420, 430, 440, 450, 460 may be homogeneous layers.

Referring to FIG. 1A, in one or more embodiments, the first conductive layer 410 and/or third conductive layer 430 and/or fourth conductive layer 440 and/or sixth conductive layer 460 may comprise (or consist essentially of) a first conductive material. In one or more embodiments, each of the conductive layers 410, 430, 440, 460 may comprise (or consist essentially of) the first conductive material. The first conductive material may be a metallic material.

In one or more embodiments, the second conductive layer 420 and/or fifth conductive layer 450 may comprise (or consist essentially) of a second conductive material. In one or more embodiments, each of the conductive layers 420, 450 may comprise (or consist essentially of) the second conductive material. The second conductive material may be a metallic material. The second conductive material (e.g. of layers 420, 450) may be different from the first conductive material (e.g. of layers 410, 430, 440, 460). The second conductive material may have a different composition from the first conductive material.

In one or more embodiments, the second conductive material (e.g., of layers 420, 450) may have a conductivity which is greater than that of titanium nitride (for example, TiN). In one or more embodiments, the second conductive material (e.g., of layers 420, 450) may have a conductivity which is greater than that of the first conductive material (e.g. of layers 410, 430, 440, 460).

In one or more embodiments, the second conductive material (e.g., of layers 420, 450) may be alpha-tantalum (also referred to as α-tantalum). In one or more embodiments, the alpha-tantalum may have a body-centered cubic (BCC) structure. In one or more embodiments, the alpha-tantalum may include a pure alpha-tantalum. The pure alpha-tantalum may include impurities (for example, trace impurities). In one or more embodiments, the alpha-tantalum may include a doped alpha-tantalum. The doped alpha-tantalum may include impurities (for example, more than trace impurities). For example, the doped alpha-tantalum may be doped to include nitrogen impurities (for example, nitrogen atoms). In one or more embodiments, the nitrogen (or other impurities) may be introduced as the alpha-tantalum is being made. The alpha-tantalum may, for example, be made by a sputtering process. Hence, in one or more embodiments, the second conductive material (e.g., of layers 420, 450) may include alpha-tantalum (also referred to as α-tantalum). The alpha-tantalum may include a pure alpha-tantalum and/or doped alpha-tantalum.

In one or more embodiments, the second conductive layer 420 and/or the fifth conductive layer 450 may comprise (or may consist essentially of) alpha-tantalum. The alpha-tantalum may include a pure alpha-tantalum and/or doped alpha-tantalum. In one or more embodiments, the second conductive layer 420 and/or the fifth conductive layer 450 may include a combination pure alpha-tantalum and doped alpha-tantalum. The combination may, for example, be as a mixture or the combination may be as a graded layer or the combination may be as a stack of sub-layers. In one or more embodiments, each of the conductive layers 420, 450 may comprise (or may consist essentially of) alpha-tantalum.

In one or more embodiments, the first conductive material (e.g., of layers 410, 430, 440, 460) may include tantalum nitride (for example, TaN).

In one or more embodiments, the first conductive layer 410 and/or third conductive layer 430 and/or fourth conductive layer 440 and/or sixth conductive layer 460 may comprise (or may consist essentially of) tantalum nitride (for example, TaN). In one or more embodiments, each of the conductive layers 410, 430, 440, 460 may comprise (or may consist essentially of) tantalum nitride (for example, TaN).

In one or more embodiments, the second conductive material (e.g., of layers 420, 450) may include alpha-tantalum while the first conductive material (e.g., of layers 410, 430, 440, 460) may include tantalum nitride.

In one or more embodiments, the second conductive layer 420 and/or fifth conductive layer 450 may comprise (or may consist essentially of) alpha-tantalum while the first conductive layer 410 and/or third conductive layer 430 and/or fourth conductive layer 440 and/or sixth conductive layer 460 may comprise (or may consist essentially of) tantalum nitride. In one or more embodiments, each of the second conductive layer 420 and fifth conductive layer 450 may comprise (or may consist essentially of) alpha-tantalum while each of the first conductive layer 410, third conductive layer 430, fourth conductive layer 440 and sixth conductive layer 460 may comprise (or may consist essentially of) tantalum nitride.

In one or more embodiments, the second conductive layer 420 and/or the fifth conductive layer 450 may comprise beta-tantalum. In one or more embodiments, the second conductive layer 420 and/or the fifth conductive layer 450 may comprise (or may consist essentially of) alpha-tantalum and beta-tantalum. The second conductive layer 420 and/or the fifth conductive layer 450 may, for example, comprise a mixture or combination of alpha-tantalum and beta-tantalum. In one or more embodiments, the combination may be a graded layer or the combination may include two or more sub-layers of materials. In one or more embodiments, the atomic percent of alpha-tantalum may be greater than the atomic percent of beta-tantalum.

Other materials may also be used for the first conductive layer 410 and/or second conductive layer 420 and/or third conductive layer 430 and/or fourth conductive layer 440 and/or fifth conductive layer 450 and/or sixth conductive layer 460.

Referring again to FIG. 1A, as noted above, in some embodiments, the first conductive layer 410 and/or third conductive layer 430 and/or fourth conductive layer 440 and/or sixth conductive layer 460 may comprise (or may consist essentially of) a first conductive material while the second conductive layer 420 and/or fifth conductive layer 450 may comprise (or may consist essentially of) a second conductive material.

As another example, the second conductive material (e.g., of layers 420, 450) may include a metal while the first conductive material (e.g., of layers 410, 430, 440, 460) may include a nitride of the metal. For example, the second conductive material may include titanium metal while the first conductive material may include titanium nitride. As another example, second conductive material may include tungsten metal while the first conductive material may include tungsten nitride.

In one or more embodiments, the second conductive material (e.g. of layers 420, 450) may include a metallic alloy. In one or more embodiments, the first conductive material (e.g., of layers 410, 430, 440, 460) may include a nitride of a metallic element used in the alloy. As an example, second conductive material may include a tantalum alloy while the first conductive material may include tantalum nitride. As another example, second conductive material may include a titanium alloy while the first conductive material may include titanium nitride. As another example, second conductive material may include tungsten alloy while the first conductive material may include tungsten nitride.

In one or more embodiments, the first conductive material (e.g. of layers 410, 430, 440, 460) as well as the second conductive material (e.g. of layers 420, 450) may be materials which can be etched using the same etch chemistry.

Hence, in one or more embodiments, the bottom electrode EB and/or the top electrode ET may be formed using a single etch chemistry. This may permit a single etch chemistry for forming the bottom electrode EB and/or for forming the top electrode ET. In one or more embodiments, both the bottom electrode EB and the top electrode ET may be formed using the same etch chemistry. Hence, in one or more embodiments, the layers 410, 420, 430 may be formed of materials which can be etched using the same etch chemistry. In one or more embodiments, the layers 440, 450, 460 may be formed of materials which can be etched using the same etch chemistry. In one or more embodiments, the layers 410, 420, 430, 440, 450, 460 may be formed of materials which can be etched using the same etch chemistry.

In one or more embodiments, the resistivity of the second conductive material (e.g. of layers 420, 450) may be about 100 micro-ohms centimeter or less. In one or more embodiments, the resistivity of the second conductive material may be about 70 micro-ohms centimeter or less. In one or more embodiments, the resistivity of the second conductive material may be about 60 micro-ohms centimeter or less. In one or more embodiments, the resistivity of the second conductive material may be about 50 micro-ohms centimeter or less. In one or more embodiments, the resistivity of the second conductive material may be about 40 micro-ohms centimeter or less. In one or more embodiments, the resistivity of the second conductive material may be about 30 micro-ohms centimeter or less.

Other materials for the conductive layers 410, 420, 430, 440, 450, 460 may also be possible.

In one or more embodiments, the first conductive layer 410 and/or the third conductive layer 430 and/or fourth conductive layer 440 and/or the sixth conductive layer 460 may include one or more conductive materials. In one or more embodiments, the conductive material may include a metallic material. In one or more embodiments, the metallic material may comprise one or more metallic elements (e.g., chemical elements from the periodic table of elements). For example, the metallic material may include one or more periodic table chemical elements selected from the group consisting of Ti (titanium), Ta (tantalum), W (tungsten), Cu (copper), Ag (silver), Au (gold) and Al (aluminum). In one or more embodiments, the metallic material may include N (nitrogen). The metallic elements may be in any form, such as, a metal, a metallic alloy or a metallic compound. Hence, in one or more embodiments, the metallic material may, for example, include a metal and/or a metallic alloy and/or a metallic compound. In one or more embodiments, the metallic material may include a metallic nitride.

In one or more embodiments, the first conductive layer 410 and/or the third conductive layer 430 and/or fourth conductive layer 440 and/or the sixth conductive layer 460 may include the chemical element Ta (tantalum).

In one or more embodiments, the first conductive layer 410 and/or the third conductive layer 430 and/or fourth conductive layer 440 and/or the sixth conductive layer 460 may include a Ta-containing material. A Ta-containing material may be any material that includes the chemical element Ta (tantalum). Ta-containing material may include, for example, a metal and/or a metallic alloy and/or a metallic compound. In one or more embodiments, the Ta-containing material may also include the chemical element N (nitrogen).

In one or more embodiments, the first conductive layer 410 and/or the third conductive layer 430 and/or fourth conductive layer 440 and/or the sixth conductive layer 460 may include the chemical element Ta (tantalum) and the chemical element N (nitrogen).

In one or more embodiments, the first conductive layer 410 and/or the third conductive layer 430 and/or fourth conductive layer 440 and/or the sixth conductive layer 460 may include one or more materials selected from the group consisting of titanium metal, tantalum metal, tungsten metal, copper metal, gold metal, silver metal, aluminum metal, titanium metal, tantalum metal, tungsten metal, copper metal, gold metal, silver metal, titanium nitride, tantalum nitride, tungsten nitride, copper nitride, gold nitride, silver nitride, and aluminum nitride.

In one or more embodiments, the first conductive layer 410 and/or third conductive layer 430 and/or fourth conductive layer 440 and/or sixth conductive layer 460 may comprise (or may consist essentially of) tantalum nitride. In one or more embodiments, the first conductive layer 410 and/or third conductive layer 430 and/or fourth conductive layer 440 and/or sixth conductive layer 460 may each be homogeneous layers.

In one or more embodiments, the second conductive layer 420 and/or the fifth conductive layer 450 may include one or more conductive materials. In one or more embodiments, the conductive material may include a metallic material. In one or more embodiments, the metallic material may comprise one or more metallic elements (e.g., elements from the periodic table of elements). For example, the metallic material may include one or more elements selected from the group consisting of Ti (titanium), Ta (tantalum), W (tungsten), Cu (copper), Ag (silver), Au (gold) and Al (aluminum). In one or more embodiments, the metallic material may include N (nitrogen). In one or more embodiments, the metallic material may, for example, include a metal, a metallic alloy and/or a metallic compound. In one or more embodiments, the metallic material may include a metallic nitride.

In one or more embodiments, the second conductive layer 420 and/or the fifth conductive layer 450 may include one or more materials selected from the group consisting of titanium metal, tantalum metal, tungsten metal, copper metal, gold metal, silver metal, aluminum metal, titanium alloy, tantalum alloy, tungsten alloy, copper alloy, gold alloy, silver alloy, titanium nitride, tantalum nitride, tungsten nitride, copper nitride, gold nitride, silver nitride, and aluminum nitride.

In one or more embodiments, the thickness of each of conductive layers 410, 430, 440, 460 may be about 20 nm or less. In one or more embodiments, the thickness of each of the conductive layers 410, 430, 440, 460 may be about 15 nm or less. In one or more embodiments, the thickness of each the conductive layers 410, 430, 440, 460 may be about 10 nm or less.

In one or more embodiments, the thickness of conductive layer 420 and/or conductive layer 450 may be about 100 nm (nanometer) or less. In one or more embodiments, the thickness of conductive layer 420 and/or conductive layer 450 may be about 90 nm or less. In one or more embodiments, the thickness of conductive layer 420 and/or conductive layer 450 may be about 80 nm or less. In one or more embodiments, the thickness of conductive layer 420 and/or conductive layer 450 may be about 70 nm or less. In one or more embodiments, the thickness of each of the conductive layer 420 and/or conductive layer 450 may be about 60 nm or less. In one or more embodiments, the thickness of second conductive layer 420 and/or fifth conductive layer 450 may be about 50 nm or less.

In one or more embodiments, the resistivity of the second conductive layer 420 and/or fifth conductive layer 450 may be about 100 micro-ohms centimeter or less. In one or more embodiments, the resistivity of the second conductive layer 420 and/or fifth conductive layer 450 may be about 70 micro-ohms centimeter or less. In one or more embodiments, the resistivity of the second conductive layer 420 and/or fifth conductive layer 450 may be about 60 micro-ohms centimeter or less. In one or more embodiments, the resistivity of the second conductive layer 420 and/or fifth conductive layer 450 may be about 50 micro-ohms centimeter or less. In one or more embodiments, the resistivity of the second conductive layer 420 and/or fifth conductive layer 450 may be about 40 micro-ohms centimeter or less. In one or more embodiments, the resistivity of the second conductive layer 420 and/or fifth conductive layer 450 may be about 30 micro-ohms centimeter or less.

By using the appropriate materials for the first and second electrodes EB, ET it may be possible to achieve desirable combinations of electrode thicknesses and electrode sheet resistances. For example, in some embodiments, it may be desirable to reduce the thickness of the electrodes while keeping the sheet resistance of the capacitor electrodes EB, ET at some relatively low value. While not wishing to be bound by theory, it may be possible that reducing electrode thickness may help to reduce electrode bowing.

Paragraph A: In one or more embodiments, the thicknesses of the first electrode EB and/or second electrode ET may be about 100 nm or less. In one or more embodiments, the thickness of the first electrode EB and/or second electrode ET may be about 90 nm or less. In one or more embodiments, the thickness of the first electrode EB and/or second electrode ET may each be about 80 nm or less. In one or more embodiments, the thickness of the first electrode EB may each be about 70 nm or less. In one or more embodiments, the thickness of the first electrode EB may each be about 60 nm or less.

Paragraph B: In one or more embodiments, the sheet resistance of the first electrode EB and/or second electrode may about 10 ohms per square or less. In one or more embodiments, the sheet resistance of the first electrode EB and/or second electrode ET may about 7.5 ohms per square less. In one or more embodiments, the sheet resistance of the first electrode EB and/or second electrode ET may about 6 ohms per square or less. In one or more embodiments, the sheet resistance of the first electrode EB and/or second electrode ET may about 4.5 ohms per square or less.

Embodiments of the invention may include combinations of electrode thicknesses from Paragraph A above and electrode sheet resistance from Paragraph B above. These combination may possibly be achieved by using appropriate materials for the capacitor electrode EB, ET. As an example, in one or more embodiments, it may be possible for the first electrode EB and/or second electrode ET to have a thickness of about 100 nm or less with a sheet resistance of about 10 ohms per square or less. Given an electrode thickness of about 100 nm or less it may be possible to reduce the sheet resistance to about 7.5 ohms per square to less, to about 6 ohms per square or less, to about 4.5 ohms per square or less. Given a sheet resistance of about 10 ohms per square or less, it may be possible to reduce the thickness to about 90 nm or less, to about 80 nm or less, to about 70 nm or less, to about 60 nm or less. As another example, in one or more embodiments, it may be possible to have an electrode thickness of about 80 nm or less with an electrode sheet resistance of about 6 ohms per square or less. As another example, in one or more embodiments, it may be possible to have an electrode thickness of about 60 nm or less with an electrode sheet resistance of about 4.5 ohms per square or less. Other combinations may also be possible.

In one or more embodiments, it may also be desirable to use a larger film thickness for the capacitor electrodes while decreasing the sheet resistance of the electrodes.

Paragraph C: In one or more embodiments, the thickness of the first electrode EB and/or second electrode ET may each be about 300 nm or less. In one or more embodiments, the thickness of the first electrode EB and/or second electrode ET may be about 275 nm or less. In one or more embodiments, the thickness of the first electrode EB and/or second electrode ET may each be about 250 nm or less. In one or more embodiments, the thickness of the first electrode EB and/or second electrode ET may each be about 200 nm or less. In one or more embodiments, the thickness of the first electrode EB and/or second electrode ET may each be about 190 nm or less.

Paragraph D: In one or more embodiments, the sheet resistance of the first electrode EB and/or second electrode ET may about 3 ohms per square or less. In one or more embodiments, the sheet resistance of the first electrode EB and/or second electrode ET may about 2.5 ohms per square less. In one or more embodiments, the sheet resistance of the first electrode EB and/or second electrode ET may about 2 ohms per square or less.

Embodiments of the invention may include combinations of electrode thicknesses from Paragraph C above and electrode sheet resistance from Paragraph D above. These combinations may possibly be achieved using appropriate materials for electrodes EB, ET. For example, in one or more embodiments, it may be possible for the first electrode EB and/or second electrode ET to have a thickness of about 300 nm or less with a sheet resistance of about 3 ohms per square or less. Given a thickness of about 300 nm or less, it may be possible to reduce the sheet resistance to about 2.5 ohms per square or less, or to about 2 ohms per square or less. Given a sheet resistance of about 3 ohms per square or less, it may be possible to reduce the thickness to about 275 nm or less, to about 250 nm or less, to about 200 nm or less, or to about 190 nm or less. As another example, in one or more embodiments, it may be possible to have an electrode thickness of about 250 nm or less with an electrode sheet resistance of about 2.5 ohms per square or less. As another example, in one or more embodiments, it may be possible to have an electrode thickness of about 200 nm or less with an electrode sheet resistance of about 2 ohms per square or less. As another example, in one or more embodiments, it may be possible to have an electrode thickness of about 190 nm or less with an electrode sheet resistance of about 2 ohms per square or less. Other combinations may also be possible.

In one or more embodiments, the thickness of the dielectric layer 510 may be about 100 nm or less. In one or more embodiments, the thickness of the conductive layer 510 may be about 70 nm or less. In one or more embodiments, the thickness of the dielectric layer 510 may be about 60 nm or less. In one or more embodiments, the thickness of the dielectric layer 510 may be about 50 nm or less.

Referring to FIG. 1A, a conductive via Vn(1) may be disposed over the conductive layer 460. A metal line Mn+1(1) may be disposed over the conductive via Vn(1). The metal line Mn+1(1) is part of the metallization level Mn+1. In one or more embodiments, the metallization level Mn+1 may be the final metallization level of the semiconductor structure. In the embodiment shown in FIG. 1A, the conductive structure 110 includes a conductive via Vn(1) which is electrically coupled between the metallization level Mn and the metallization level Mn+1. In the embodiment shown, the conductive via Vn(1) electrically couples the metal line Mn+1(1) to the conductive layer 460. The metal line Mn+1(1) may include a pad structure. The metal line Mn(1), capacitor 310, and the conductive via Vn(1) may all be embedded within one or more dielectric layers. In the embodiment shown in FIG. 1A, the metal line Mn(1), capacitor 310 and the conductive via Vn(1) may all be embedded within an interlevel dielectric layer ILDn.

The metal line Mn+1(1) may be embedded within a dielectric layer 260. In one or more embodiments, the dielectric layer 260 may, for example, represent another interlevel dielectric layer (e.g. interlevel dielectric layer ILD(n+1) in the case that additional metallization levels are above the metallization level Mn+1. In this case, there may be one or more additional metallization levels as well as one or more dielectric layers above the dielectric layer 260.

In one or more embodiments, the dielectric layer 260 may also represent a final dielectric or passivation layer in the case that the metallization level Mn+1 may be the final metallization level.

The semiconductor structure 110 includes a capacitor 310. The capacitor 310 may be electrically coupled between the first metallization level Mn and the second metallization level Mn+1. The capacitor 310 shown in FIG. 1A is coupled between a first metallization level Mn and a second metallization level Mn+1. The first and second metallization levels may be adjacent levels (such as Metal-1 is adjacent to Metal-2, Metal-2 is adjacent to Metal-3, etc). In the embodiments shown, no other metallization level is between the first metallization level Mn and the second metallization level Mn+1. As an example, Mn may correspond to Metal-1 while Mn+1 may correspond to Metal-2. As another example, Mn may correspond to Metal-2 while Mn+1 may correspond to Metal-3.

FIG. 2 shows a semiconductor structure 110′ which is an example of the embodiment shown in FIG. 1A. The semiconductor structure 110′ may, for example, represent a semiconductor chip and/or an integrated circuit and/or a semiconductor device. The semiconductor structure 110′ includes a substrate 210. Overlying the substrate 210 is a layer 220. In the embodiment shown, the layer 220 comprises a dielectric layer 222 overlying the substrate 210 and an interlevel dielectric layer ILD1 overlying the dielectric layer 222. The layer 220 further includes conductive contacts C1, C2. The layer 220 further includes a metallization level M1 that includes a metal line M1(1) and a metal line M1(2)). The layer 220 further includes conductive vias V1(1), V1(2).

The conductive contacts C1, C2 are embedded within the dielectric layer 222. The first metallization level M1 is formed over the dielectric layer 222. The first metallization level M1 includes metal line M1(1) and metal line M1(2). The metal lines M1(1), M1(2) are embedded within a first interlevel dielectric layer ILD1. Conductive vias V1(1) and V1(2) are also embedded within the interlevel dielectric layer ILD1.

A second metallization level M2 is formed over the interlevel dielectric layer ILD1. The second metallization level M2 includes metal lines M2(1) and M2(2). The metal lines M2(1) and M2(2) are embedded within a second interlevel dielectric layer ILD2. Conductive vias V2(1), V2(2) as well as capacitor 310 are embedded within the dielectric layer ILD2.

A third metallization level M3 is formed over the interlevel dielectric layer ILD2. The third metallization level M3 includes metal lines M3(1) and M3(2). The metal lines M3(1) and M3(2) are embedded within a dielectric layer 260. The dielectric layer 260 corresponds to a third interlevel dielectric layer ILD3. The conductive vias V3(1), V3(2) are also embedded within dielectric layer 260.

A fourth metallization level M4 is disposed over the interlevel dielectric layer ILD3. The fourth metallization level M4 includes the metal line M4(1). The metal line M4(1) is embedded within a dielectric layer 290. The fourth metallization level M4 may be the final metal level for the semiconductor structure 110′. The structure 110′ may, for example, represent a semiconductor chip 110′. The semiconductor chip 110′ may include an integrated circuit.

Referring to FIG. 2, conductive via V1(1) electrically couples metal line M1(1) to metal line M2(1). Conductive via V2(2) electrically couples conductive line M1(2) to conductive line M2(2).

Likewise, conductive via V2(2) electrically couples metal line M2(2) to metal line M3(2). Likewise, conductive via V3(1) electrically couples metal line M3(1) to metal line M4(1) and conductive via V3(2) electrically couples metal line M3(2) to metal line M4(1).

A conductive via may be electrically coupled between a one metallization level and another metallization level. A conductive contact may be electrically coupled between a metallization level and a substrate.

The semiconductor structure 110′ includes a capacitor 310 (as described above with respect to FIG. 1A). The capacitor 310 is coupled between the metallization level M2 and the metallization level M3. FIG. 2 shows how the capacitor 310 may be electrically coupled between a first portion of the substrate 210 and a second portion of same substrate 210 of the same chip. It may also be possible to couple one or more of the electrodes of the capacitor 310 to other chips. More generally, the first electrode EB of the capacitor 310 may be electrically coupled to a first node on the same chip as the capacitor 310 or to a first node on a different chip from the capacitor 310. Likewise, the second electrode ET of the capacitor 310 may be electrically coupled to a second node on the same semiconductor structure (for example, semiconductor chip and/or integrated circuit and/or semiconductor device) as the capacitor 310 or to a node on a different chip from the capacitor 310.

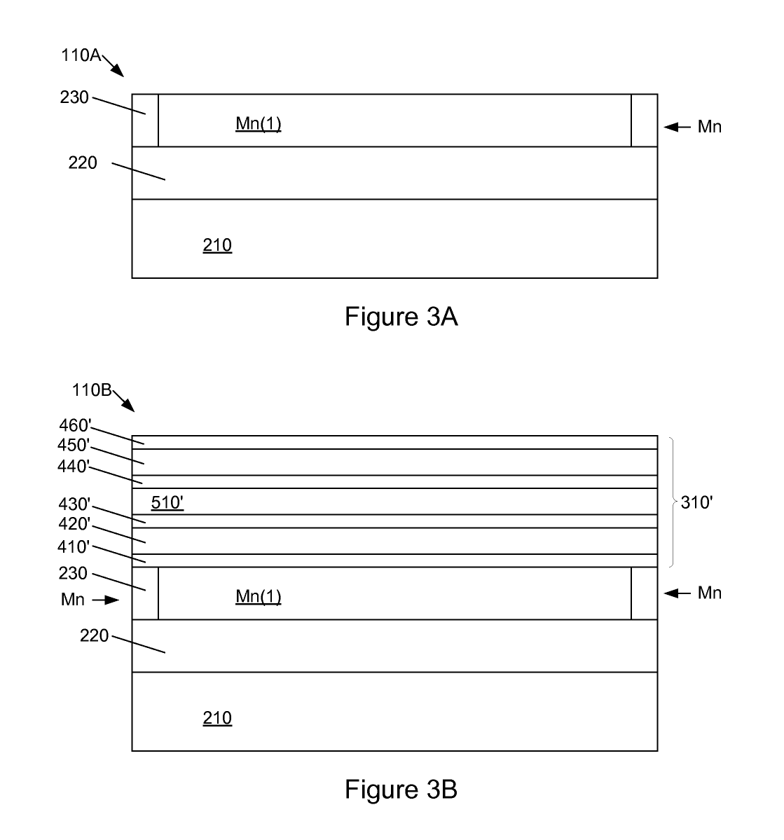

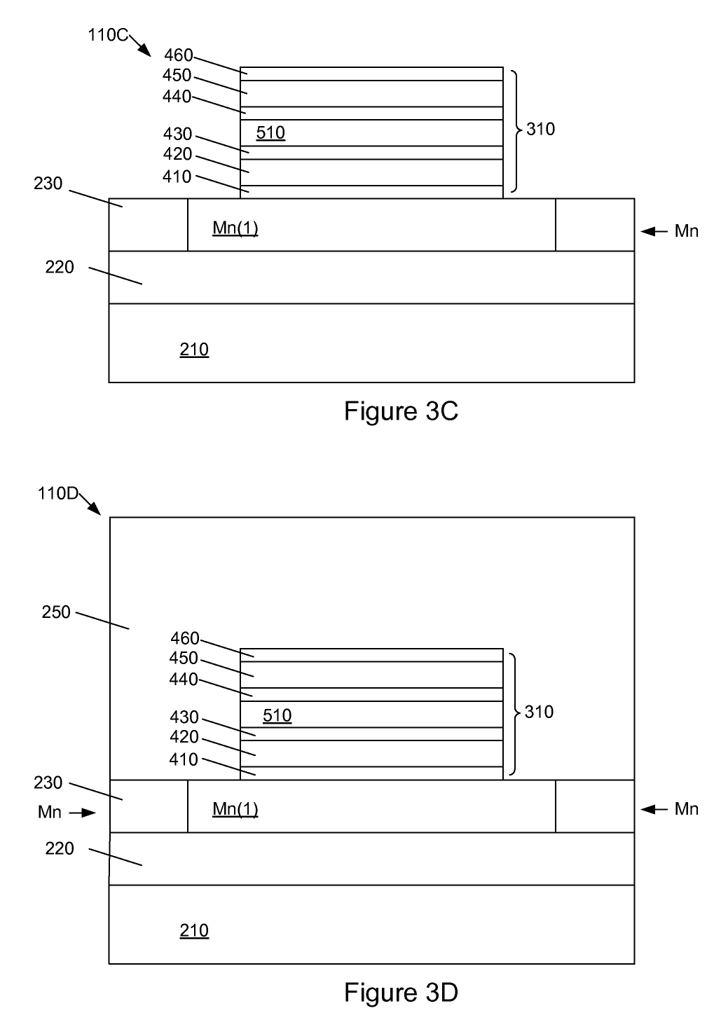

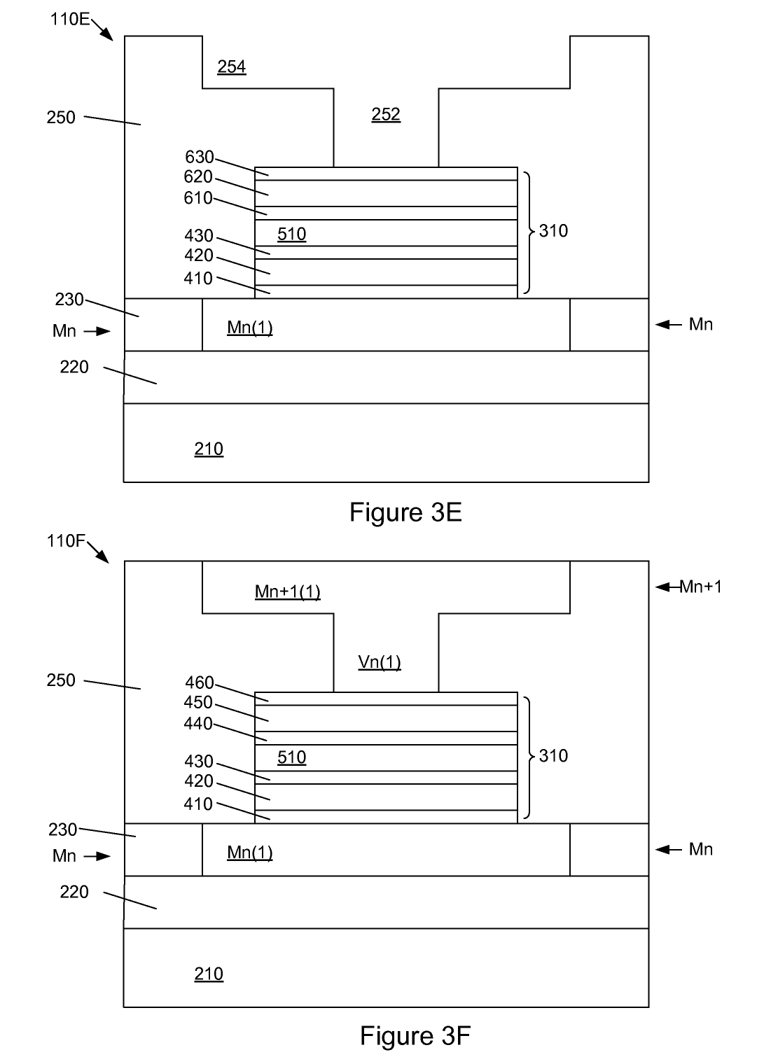

FIGS. 3A through 3F show a process for making the semiconductor structure 110F shown in FIG. 3F. The process is an embodiment of the present invention. The semiconductor structure 110F is also an embodiment of the present invention. The semiconductor structure 110F may, for example, represent a semiconductor chip or an integrated circuit.

FIG. 3A shows a semiconductor structure 110A that includes a substrate 210 and layer 220 disposed over the substrate 210. A metal line Mn(1) is disposed over the layer 220 and embedded in a dielectric layer 230.

Referring to FIG. 3B, the conductive layers 410′, 420′, 430′ are formed over the structure 110A from FIG. 3A, the dielectric layer 510′ is formed over the conductive layer 430′, and the conductive layers 440′, 450′, 460′ are formed over the dielectric layer 510′. This results in the formation of a layer stack over the structure 110A from FIG. 3A to form the structure 110B in FIG. 3B.

Referring to FIG. 3C, the layer stack 310′ from FIG. 3B may then be etched to form the etch stack 310 shown in FIG. 3C. The etched stack 310 includes the layers 410, 420, 430, 510, 440, 450, 460 which are simply portions of layers 410′, 420′, 430′, 510′, 440′, 450′, 460′. The etch stack 310 represent a capacitor 310.

In one or more embodiments, the stack 310′ may be etched using a single masking step to form the etched stack 310 shown in FIG. 3C. The etch results in the structure 110C shown in FIG. 3C. It is noted that the layers 410, 420, 430, 510, 440, 450, 460 are etched versions of the layers 410′, 420′, 430′, 510′, 440′, 450′, 460′ shown in FIG. 3B.

In one or more embodiments, the etch performed may be a dry etch. An example of a dry etch is a plasma etch. In one or more embodiments, the etch may be performed so that the layers 460′, 450′ and 440′ may be etch using the same etch chemistry. Likewise, the layers 430′, 420′ and 410′ may be etched using the same etch chemistry (and, possibly, the same etch chemistry as used for layers 460′, 450′, 440′). In one or more embodiments, the dielectric layer 510′ may be etched using a different etch chemistry from that used for the conductive layers. However, in one or more embodiments, may be conceivable that the etch chemistry used for the dielectric layer 510′ be the same as for layers 460′, 450′, 440′ and for layers 430′, 420′ and 410′. The stack 310 represents a capacitor 310 that includes a first electrode EB and a second electrode ET.

Referring to FIG. 3D, a dielectric layer 250 may then formed over the structure 110C from FIG. 3C to form the structure 110D shown in FIG. 3D.

Referring to FIG. 3E, the dielectric layer 250 may then be etched to form the structure 110E shown in FIG. 3E. The structure 110E shown in FIG. 3E includes a first opening 252 and a second opening 254 within the dielectric layer 250. The first opening 252 may be a via opening and may be in the form of a hole (for example, round, oval, square or rectangular). The second opening 254 may be a trench opening in the form of a trench. The openings may be formed within the dielectric 250 using an etch process associated with a damascene process such as a dual damascene process. Hence, the composite opening (254,252) may be referred to as a dual-damascene opening.

The FIG. 3F shows a structure 110F. Referring to FIG. 3F, the opening 252 and the opening 254 may then be filled with a conductive material to form the conductive via Vn(1) and the metal line Mn+1(1). The conductive material may be a metallic material. The filling of the opening 252 and the opening 254 may be performed by first depositing a metallic seed layer by, for example, a physical vapour deposition process, over the surfaces of the openings 252, 254. Then a metallic material may be deposited into the openings 252, 254 by, for example, an electroplating process. In one or more embodiments, the metallic material may be copper metal or a copper alloy (such as a copper-aluminium alloy). Prior to forming a seed layer, a barrier layer may be formed in the openings 252, 254 by, for example, a physical vapour deposition process or a chemical vapour deposition process.

Regardless of the process used, it is possible, in one or more embodiments, that the conductive via Vn(1) and/or the metal line Mn+1(1) may end up being either copper metal or a copper alloy (such as a copper-aluminum alloy). In one or more embodiments, the metal line Mn(1) as well as Mn+1(1) may be copper metal or a copper alloy (such as copper-aluminum alloy). In this case, in or more embodiments, it is possible that the conductive via Vn(1) may be formed of the same material as the conductive lines. In one or more embodiments, the conductive via Vn(1) may also be formed of copper metal or a copper alloy.

In another embodiment of the invention, it is possible that the upper metal line Mn+1(1) as well as the conductive via Vn(1) comprise copper metal or a copper alloy. However, the lower metal line Mn(1) may comprise a material that is different from either copper metal or a copper alloy. For example, the lower metal line Mn(1) may comprise aluminium metal or an aluminium alloy.

In another embodiment of the invention, it is possible that neither the upper metal line Mn+1(1) nor the lower metal line Mn(1) comprise either copper metal or a copper alloy. Instead, it may be possible, that both metal lines comprise another conductive or metallic material. For example, in an embodiment, the lower metal line Mn(1) as well as the upper metal line Mn+1(1) comprise either aluminium metal or an aluminium alloy. In this case, it is possible that the conductive via Vn(1) may comprise tungsten metal or a tungsten alloy.

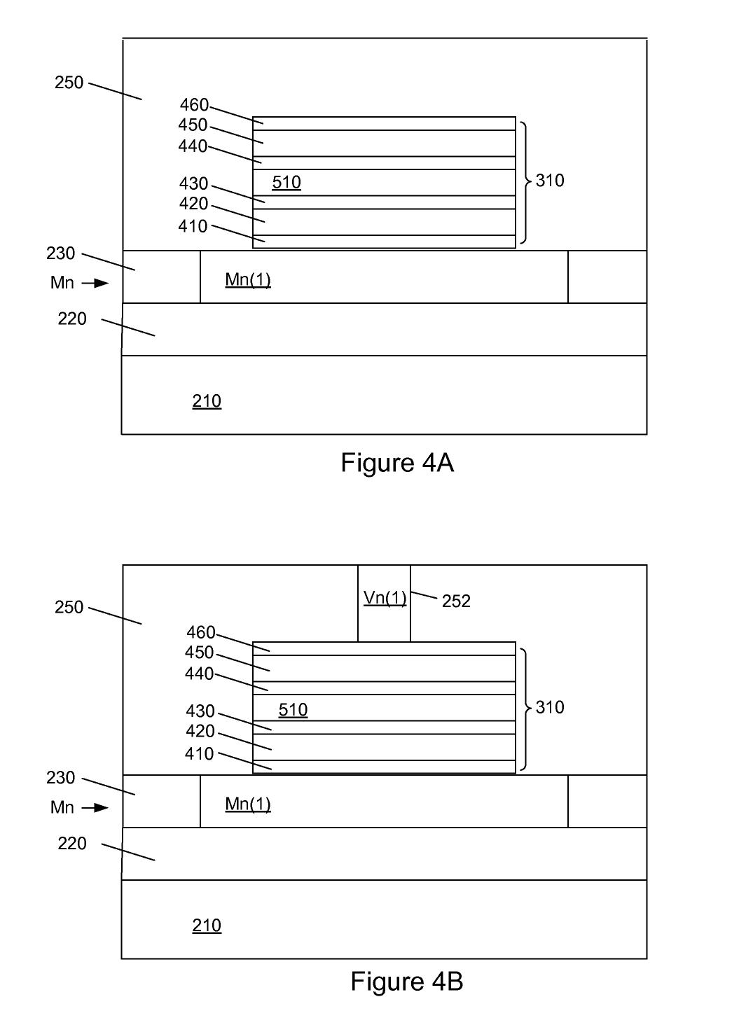

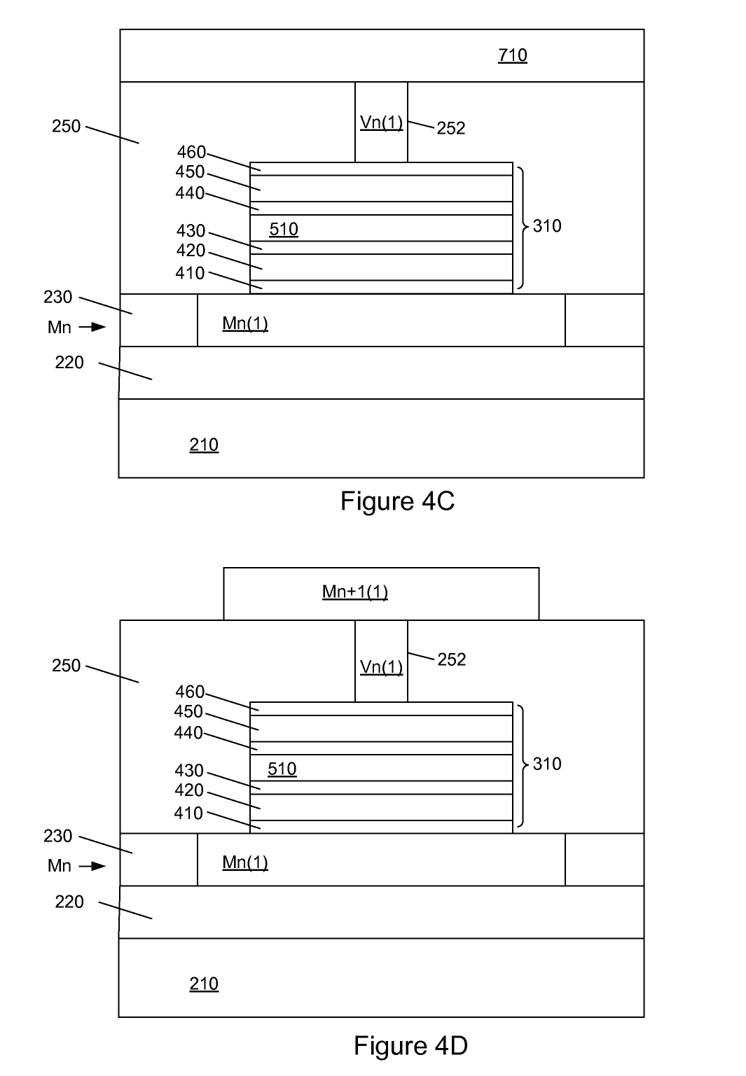

In one or more embodiments, the conductive via Vn(1) as well as the metal line Mn+1(1) may be formed by a different process which is also an embodiment of the present invention. This process is shown in FIGS. 4A through 4D.

The structure of FIG. 4A is similar to that of the structure 110D shown in FIG. 3D. FIG. 4A shows the capacitor 310 covered by a dielectric layer 250.

Referring to FIG. 4B, it is seen that it is possible that a via opening 252 be formed in the dielectric layer 250. A conductive material may then be deposited within the opening 252 to form the conductive via Vn(1).

Referring to FIG. 4C, a conductive layer 710 may then be deposited over the conductive via Vn(1) and, optionally, over the dielectric layer 250. Referring to FIG. 4D, the conductive layer 710 may then be etched to form the metal line Mn+1(1) which is part of the metallization level Mn+1. In one or more embodiments, it is possible that the process shown in FIGS. 4A through 4D may be well suited when the metal lines Mn(1) and Mn+1(1) comprise aluminium metal or an aluminium alloy. It is noted that the process depicted is FIGS. 4A through 4D is an embodiment of the present invention. Also, the semiconductor structure shown in FIG. 4D is an embodiment of the present invention. The process shown in FIGS. 4A through 4D is applicable, for example, for the capacitors 310 shown in FIGS. 1A through 1D.

Each of the dielectric layers described herein may comprise any dielectric material. In one or more embodiments, the dielectric material may include an oxide, a nitride, an oxynitride and combinations thereof. Examples of possible oxides include, but not limited to silicon oxide, aluminum oxide, hafnium oxide, tantalum oxide, and combinations thereof. Examples of possible nitrides include, but not limited to, silicon nitride. Examples of possible oxynitrides include, but not limited to, silicon oxynitride. The dielectric material may comprise a high-k material. In one or more embodiments, the dielectric material may be a gas. In one or more embodiments, the dielectric material may be air. In one or more embodiments, it is possible that a vacuum be used as a dielectric.

In one or more embodiments, the various dielectric layers, may be formed of the same different dielectric material. In one or more embodiments, two or more of the dielectric layers may be formed of different dielectric materials.

The metal lines (e.g., Mn(1), Mn+1(1)), conductive vias (e.g., Vn(1)), as well as the conductive contacts (e.g., C1, C2 as shown in FIG. 2) may include one or more conductive materials. The conductive material may include a metallic material. The metallic material may comprise, without limitation, one or more periodic table elements from the group consisting of Al (aluminum), Cu (copper), Au (gold), Ag (silver), W (tungsten), Ti (titanium), and Ta (tantalum). The metallic material may be a material selected from the group consisting of aluminum metal, aluminum alloy, copper metal, copper alloy, gold metal, gold alloy, silver metal, silver alloy, tungsten metal, tungsten alloy, titanium metal, titanium alloy, tantalum metal, and tantalum alloy. As additional examples, the metallic material may comprise a nitride such as a refractory metal nitride. Examples include, but not limited to, TiN, TaN and WN.

It is possible that the metal line be replaced with non-conductive materials. It is also possible that the conductive materials used for any of the conductive vias or conductive contacts may be non-metallic conductive materials. For example, the conductive material may be doped polysilicon (such as n-type doped or p-type doped). The conductive material may also be formed of a conductive polymer.

In one or more embodiments, the various metal lines, conductive vias and conductive contacts may comprise the same conductive materials. In one or more embodiments, two or more of the various metal lines, conductive vias, and conductive contacts may be formed of the same conductive materials. In one or more embodiments, two or more of the various metal lines, conductive vias, and conductive contacts may comprise different conductive materials.

The present invention may apply at least to both copper and aluminum metallization systems. In one or more embodiments, the metal lines may comprise copper metal or a copper alloy. The copper alloy may be a copper-aluminum alloy. In one or more embodiments, the conductive vias may also comprise copper metal or copper alloy. In one or more embodiments, the conductive via Vn(1) may comprise tungsten metal or a tungsten alloy.

In one or more embodiments, the metal lines may comprise aluminum metal or an aluminum alloy. The aluminum alloy may be an aluminum-copper alloy. In one or more embodiments, the conductive vias may comprise tungsten metal or a tungsten alloy.

Referring, for example, to FIG. 1A, in one or more embodiments, the metal line Mn+1(1) as well as the metal line Mn(1) may comprise copper metal or copper alloy. In one or more embodiments, the metal line Mn+1(1) may comprise copper metal or copper alloy while the metal line Mn(1) may comprise aluminum metal or aluminum alloy. In one or more embodiments, the conductive via Vn(1) may comprise copper metal or a copper alloy. In one or more embodiments, the conductive via may comprise tungsten metal or a tungsten alloy.

As noted, the capacitor arrangement described herein may be part of a semiconductor structure. For example, capacitor arrangement may be part of a semiconductor chip and/or an integrated circuit and/or a semiconductor device.

One or more embodiments relate to a capacitor, comprising: a first electrode comprising a first layer including tantalum nitride, and a second layer including alpha-tantalum overlying the first layer; a dielectric layer; and a second electrode overlying the dielectric layer, the second electrode comprising a first layer including tantalum nitride and a second layer including alpha-tantalum overlying the first layer. In one or more embodiment, the capacitor may be an MIM capacitor.

One or more embodiments relate to a capacitor, comprising: a first electrode comprising a first layer consisting essentially of tantalum nitride and a second layer consisting essentially of alpha-tantalum overlying the first layer; a dielectric layer overlying the first electrode; and a second electrode overlying the dielectric layer, the second electrode comprising a first layer consisting essentially of tantalum nitride, and a second layer consisting essentially of alpha-tantalum overlying the first layer. In one or more embodiments, the capacitor may be an MIM capacitor.

One or more embodiments relate to a capacitor, comprising: a first electrode comprising a first layer including tantalum nitride, a second layer including a conductive material having a resistivity less than titanium nitride overlying the first layer; a dielectric layer; and a second electrode overlying the dielectric layer, the second electrode comprising a first layer including tantalum nitride, and a second layer including the conductive material. In one or more embodiments, the conductive material may be a metallic material. In one or more embodiments, the capacitor may be an MIM capacitor.

One or more embodiments relate to a capacitor, comprising: a first electrode; a dielectric layer overlying the first electrode; and a second electrode overlying the dielectric layer, wherein the first electrode has a sheet resistance of about 10 ohms per square or less, the second electrode has a sheet resistance of about 10 ohms per square or less, the first electrode has a thickness of about 100 nm or less, the second electrode has a thickness of about 100 nm or less. In one or more embodiments, the capacitor may be an MIM capacitor.

One or more embodiments relate to a capacitor, comprising: a first electrode; a dielectric layer overlying the first electrode; and a second electrode, wherein the first electrode has a sheet resistance of about 3 ohms per square or less, the second electrode has a sheet resistance of about 3 ohms per square or less, the first electrode has a thickness of about 300 nm or less, the second electrode has a thickness of about 300 nm or less. In one or more embodiments, the capacitor may be an MIM capacitor.

One or more embodiments relate to a method of making a capacitor, comprising: forming a first layer including tantalum nitride; forming a second layer over said first layer, said second layer including a conductive material having a resistivity less than titanium nitride; and etching the first layer and the second layer using a single etch chemistry. In one or more embodiments, the conductive material may be a metallic material. In one or more embodiments, the capacitor may be an MIM capacitor.

The disclosure herein is presented in the form of detailed embodiments described for the purpose of making a full and complete disclosure of the present invention, and that such details are not to be interpreted as limiting the true scope of this invention as set forth and defined in the appended claims.

What is claimed is:

1. A capacitor, comprising:
a first electrode comprising
a first layer including tantalum nitride, and
a second layer including alpha-tantalum overlying said first layer;
a dielectric layer overlying said first electrode; and
a second electrode overlying said dielectric layer, said second electrode comprising
a first layer including tantalum nitride, and
a second layer including alpha-tantalum overlying said first layer.

2. The capacitor of claim 1, wherein said first electrode includes a third layer including tantalum nitride overlying said second layer.

3. The capacitor of claim 2, wherein said second electrode includes a third layer including tantalum nitride overlying said second layer.

4. The capacitor of claim 1, wherein said second electrode includes a third layer including tantalum nitride overlying said second layer.

5. The capacitor of claim 1, wherein said second layer of said first electrode has a thickness of less than about 100 nm and said second layer of said second electrode has a thickness of less than about 100 nm.

6. The capacitor of claim 1, wherein said capacitor is coupled between a first metallization level and a second metallization level, said first metallization level being adjacent said second metallization level.

7. The capacitor of claim 1, wherein dielectric layer comprises a high-k material.

8. The capacitor of claim 1, wherein said dielectric layer comprises aluminum oxide.

9. A capacitor, comprising:
a first electrode comprising
a first layer consisting essentially of tantalum nitride, and
a second layer consisting essentially of alpha-tantalum overlying said first layer;
a dielectric layer overlying said first electrode; and
a second electrode overlying said dielectric layer, said second electrode comprising
a first layer consisting essentially of tantalum nitride, and
a second layer consisting essentially of alpha-tantalum overlying said first layer.

10. The capacitor of claim 9, wherein said first electrode further comprises a third layer consisting essentially of alpha-tantalum overlying said second layer.

11. The capacitor of claim 9, wherein second electrode further comprises a third layer consisting essentially of alpha-tantalum overlying said second layer.

12. The capacitor of claim 9, wherein said first electrode further comprises a third layer consisting essentially of alpha-tantalum overlying said second layer, and wherein said second electrode further comprises a third layer consisting essentially of alpha-tantalum overlying said second layer.

13. The capacitor of claim 9, wherein said dielectric layer comprises a high-k material.

14. The capacitor of claim 9, wherein said dielectric layer comprises aluminum oxide.

15. A capacitor, comprising:
a first electrode comprising
a first layer including tantalum nitride, and
a second layer including a conductive material having a resistivity less than titanium nitride overlying said first layer;
a dielectric layer overlying said first electrode; and
a second electrode overlying said dielectric layer, said second electrode comprising
a first layer including tantalum nitride, and
a second layer including said conductive material.

16. The capacitor of claim 15, wherein said first electrode includes a third layer including tantalum nitride overlying said second layer.

17. The capacitor of claim 15, wherein said second electrode includes a third layer including tantalum nitride overlying said second layer.

18. The capacitor of claim 17, wherein said second electrode includes a third layer including tantalum nitride overlying said second layer.

19. The capacitor of claim 15, wherein said second layer of said first electrode has a thickness of less than about 100 nm and said second layer of said second electrode has a thickness of less than about 100 nm.

20. The capacitor of claim 15, wherein said capacitor is coupled between a first metallization level and a second metallization level, said first metallization level being adjacent said second metallization level.

21. The capacitor of claim 15, wherein dielectric layer comprises a high-k material.

22. The capacitor of claim 15, wherein said conductive material is a metallic material.

23. A capacitor, comprising:
a first electrode;
a dielectric layer overlying said first electrode; and
a second electrode overlying said dielectric layer, wherein said first electrode has a sheet resistance of about 10 ohms per square or less, said second electrode has a sheet resistance of about 10 ohms per square or less, said first electrode has a thickness of about 100 nm or less, said second electrode has a thickness of about 100 nm or less.

24. The capacitor of claim 23, wherein said dielectric layer includes a high-k material.

25. The capacitor of claim 23, wherein said first electrode comprises tantalum nitride and said second electrode comprises tantalum nitride.

26. A capacitor, comprising:
a first electrode;
a dielectric layer overlying said first electrode; and
a second electrode,
wherein said first electrode has a sheet resistance of about 3 ohms per square or less, said second electrode has a sheet resistance of about 3 ohms per square or less, said first electrode has a thickness of about 300 nm or less, said second electrode has a thickness of about 300 nm or less.

27. The capacitor of claim 26, wherein said dielectric layer includes a high-k material.

28. The capacitor of claim 26, wherein said first electrode includes tantalum nitride and said second electrode includes tantalum nitride.

29. A method of making a capacitor, comprising:
forming a first layer including tantalum nitride;
forming a second layer over said first layer, said second layer including a conductive material having a resistivity less than titanium nitride; and
etching said first layer and said second layer using a single etch chemistry.

30. The method of claim 29, further comprising forming a third layer including tantalum nitride over said second layer before performing said etching process, and wherein said etching process includes etching said first layer, said second layer and said third layer using said single etch chemistry.

31. The method of claim 29, wherein said second layer is formed to have a thickness of about 100 nm or less.
